(19) United States
(12) Patent Application Publication
(10) Pub. No.: US 2025/0024778 A1
(43) Pub. Date: Jan. 23, 2025

(54) MOWER CUTTING UNIT HAVING BLADES AND LIFTING DEVICES

(71) Applicant: FireFly Automatix, Inc., Salt Lake City, UT (US)

(72) Inventors: Eric E. Aston, Farmington, UT (US); Mark C. LeBlanc, Salt Lake City, UT (US); Sam B. Jensen, Farmington, UT (US); Dylan Mellenthin, Riverton, UT (US); Josh Landry, Sandy, UT (US)

(21) Appl. No.: 18/356,098

(22) Filed: Jul. 20, 2023

(51) Int. Cl. A01D 34/66

(52) U.S. Cl. CPC A01D 34/667; A01D 34/664

(57) ABSTRACT

A cutting unit for a mower can include blades and separate lifting devices to cause grass to stand up before being cut by the blades. The cutting unit can include disks to which the blades and lifting devices are secured. The lifting devices can be positioned rotationally in front of the blades.

### CROSS-REFERENCE TO RELATED APPLICATIONS

N/A

### BACKGROUND

When grass is cut, and particularly longer grass, it is desirable to create lift to stand the grass up before it is cut. Rotary blades, such as those that are commonly used on lawn mowers, are shaped as an elongated rectangle with a sharpened leading edge and an upwardly angled trailing edge. This upward angle creates lift as the rotary blade spins.

### BRIEF SUMMARY

The present invention extends to a cutting unit for a mower that includes blades and separate lifting devices to cause grass to stand up before being cut by the blades. The cutting unit can include disks to which the blades and lifting devices are secured. The lifting devices can be positioned rotationally in front of the blades.

In some embodiments, the present invention may be implemented as a cutting unit for a mower that includes a disk, at least one blade that is secured to the disk and that extends outwardly beyond the disk, and at least one lifting device that is secured to the disk. Each lifting device can be positioned rotationally in front of a respective blade of the at least one blade.

In some embodiments, the disk may be a bottom disk and the cutting unit may further include a top disk. The at least one blade and the at least one lifting device may be positioned between the top disk and the bottom disk.

In some embodiments, the at least one blade may be a plurality of blades and the at least one lifting device may be a corresponding plurality of lifting devices such that one of the lifting devices is positioned rotationally in front of one of the blades.

In some embodiments, the at least one blade and the at least one lifting device may be bolted to the disk.

In some embodiments, each of the at least one lifting device may be positioned rotationally in front of the respective blade by at least 10 degrees.

In some embodiments, each of the at least one lifting device may be shaped to create lift as the disk is spun.

In some embodiments, each of the at least one lifting device may form an airfoil.

In some embodiments, each of the at least one lifting device may have a trailing edge that forms a fin.

In some embodiments, the disk may be configured to allow the at least one lifting device to be positioned rotationally in front of the respective blade at multiple different positions.

In some embodiments, the disk may include an arrangement of openings for receiving bolts that secure the at least one lifting device to the disk.

In some embodiments, the arrangement of openings may be circular.

In some embodiments, the present invention may be implemented as a mower that includes one or more cutting units. Each cutting unit may include a first disk, a plurality of blades that are secured to the first disk and that extend outwardly beyond the first disk, and a plurality of lifting devices that are secured to the first disk. Each lifting device may be positioned rotationally in front of a respective blade of the plurality of blades.

In some embodiments, the cutting unit may include a second disk and the plurality of blades and the plurality of lifting devices may be positioned between the first and second disks.

In some embodiments, the rotational position of each lifting device relative to the respective blade may be customizable.

In some embodiments, the present invention may be implemented as a cutting unit for a mower that includes a plurality of blades, and a plurality of lifting devices separate from the blades. Each lifting device may be positioned rotationally in front of and spaced from a respective one of the blades.

In some embodiments, the plurality of blades and the plurality of lifting devices may be secured to at least one disk.

In some embodiments, the at least one disk may be a top disk and a bottom disk.

In some embodiments, the plurality of blades and the plurality of lifting devices may be positioned between the top and bottom disks.

In some embodiments, the rotational position of each lifting device relative to the respective blade may be customizable.

In some embodiments, the plurality of blades may be at least four blades and the plurality of lifting devices may be at least four lifting devices.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1A and 1B are side perspective and bottom perspective views respectively of a mower deck which could include cutting units configured in accordance with embodiments of the present invention;

FIGS. 2A and 2B are bottom and side views respectively of a cutting unit which could include lifting devices in accordance with embodiments of the present invention;

FIGS. 3A and 3B are bottom and side views respectively of the cutting unit of FIGS. 2A and 2B with the addition of lifting devices;

FIG. 4 is a bottom view of top and bottom disks of a cutting unit that enable the relative positions of the blades and the lifting devices to be customized; and

FIGS. 5A-5C provide an example of a lifting device that includes a fin.

### DETAILED DESCRIPTION

A cutting unit configured in accordance with embodiments of the present invention may be used on a variety of mowers and mower decks. Embodiments will be primarily described in the context of a mower deck for commercial mowers that include multiple cutting units. However, a cutting unit configured in accordance with embodiments of the present invention could be used on a lawn mower or any other mower.

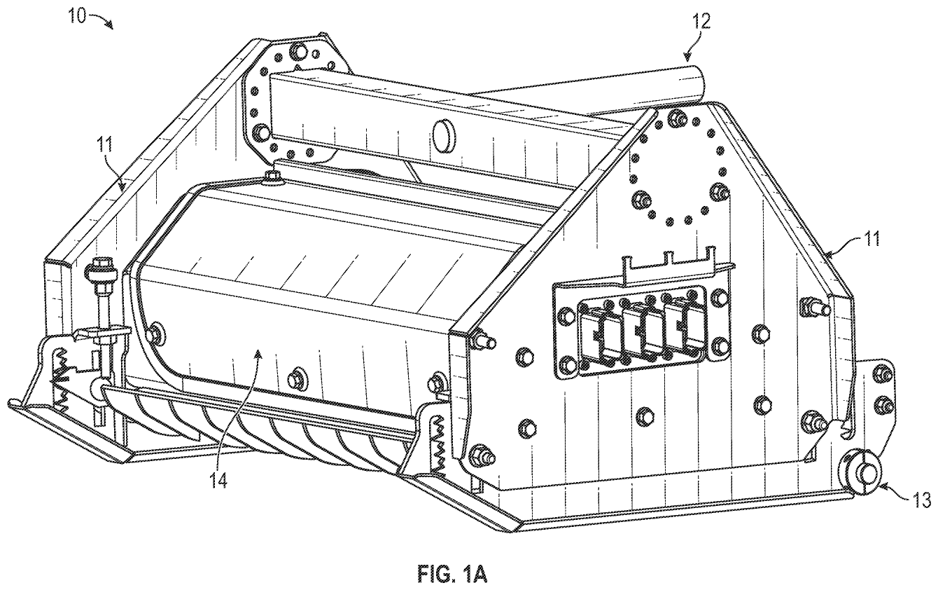

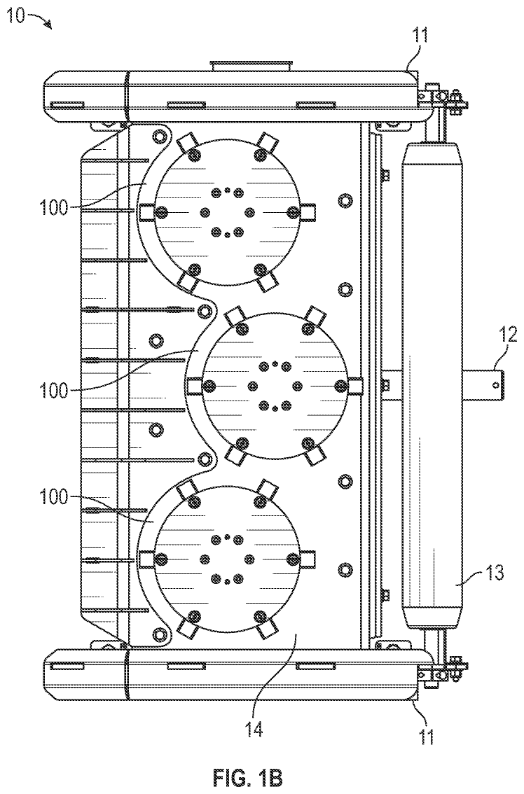

FIGS. 1A and 1B are side perspective and bottom perspective views respectively of a mower deck 10 which could include cutting units configured in accordance with embodiments of the present invention. Mower deck 10 includes a frame 11 that can be supported from a mower via a support structure 12, a rear roller 13 that supports frame 11 on the ground, an enclosure 14 that covers cutting units 100. In the depicted embodiment, mower deck 10 includes three cutting units 100. However, a mower deck could include one or more cutting units, any or all of which could be configured in accordance with embodiments of the present invention. In some embodiments, mower deck 10 could also include a front roller.

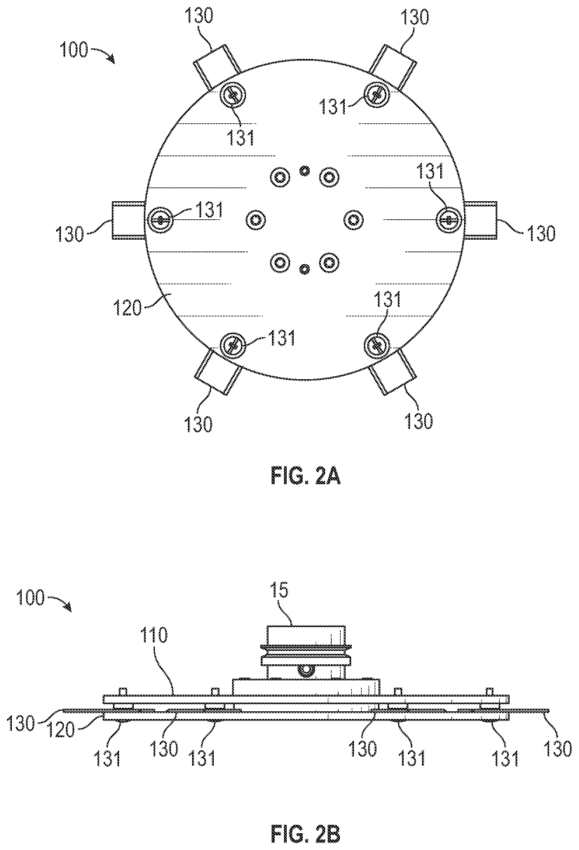

FIGS. 2A and 2B are bottom and side views respectively of a cutting unit 100. Cutting unit 100 includes a top disk 110 and a bottom disk 120 that are coupled to a shaft 15 by which these disks are spun. Multiple, independent blades 130 are secured between top disk 110 and bottom disk 120 via bolts 131 but any other suitable coupling technique could be used (e.g., clamping, welding, etc.). Each blade 130 may be held against the top side of bottom disk 120 and may extend outwardly beyond the diameter of bottom disk 120. The leading edge and possibly the trailing edge of each blade 130 may be sharpened and may therefore resemble a razor blade. In the depicted embodiment, there are six blades 130 spaces evenly around bottom disk 120. However, any reasonable number of blades 130 or even a single blade 130 could be used. Also, in some embodiments, blades 130 need not be evenly spaced around bottom disk 120.

Bottom disk 120, as a flat surface, can minimize drag as cutting unit 100 spins. However, in some embodiments, a cutting unit may not include bottom disk 120 in which case blade(s) 130 can be secured directly against top disk 120.

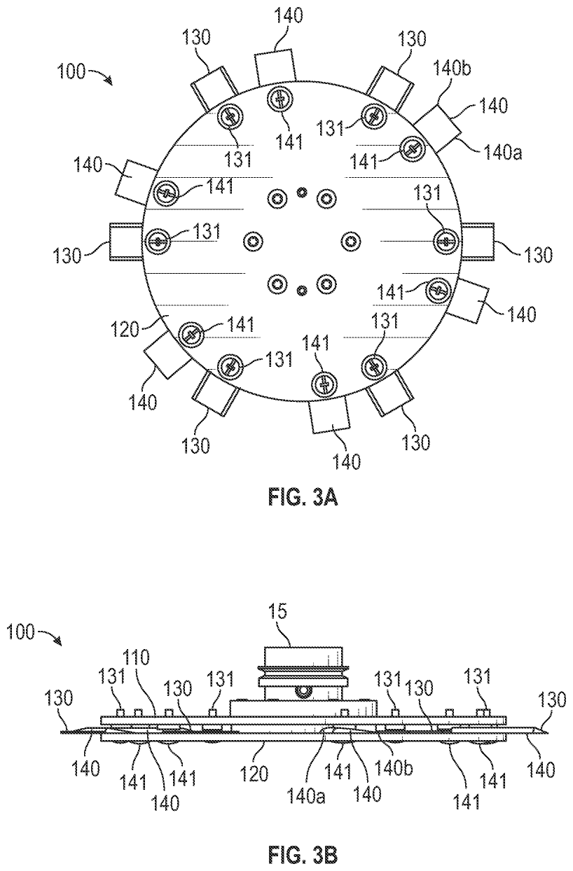

FIGS. 3A and 3B are bottom and side views respectively of cutting unit 100 when it includes lifting devices 140 in accordance with embodiments of the present invention. Lifting devices 140 are separate from blades 130 and each lifting device 140 can be positioned in front of one of blades 130. With reference to FIG. 3A, cutting unit 100 is configured to be rotated in a clockwise direction and each lifting device 140 is positioned approximately 20 degrees in front of the respective blade 130. However, lifting devices 140 could be positioned at any suitable angle in front of the respective blades 130. Each lifting device 140 may be secured between top disk 110 and bottom disk 120 via bolts 141 or another suitable coupling technique and may extend outwardly beyond the diameter of bottom disk 120.

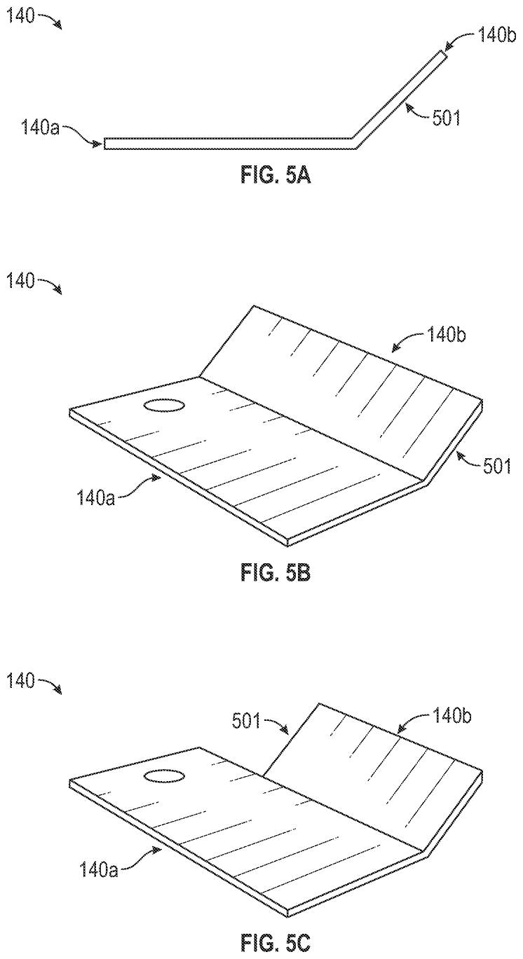

Each lifting device 140 can be shaped to create lift as cutting unit 100 spins. For example, in the depicted embodiment, each lifting device 140 has a leading edge 140a and a trailing edge 140b that form an airfoil. In other embodiments, each lifting device 140 could have a trailing edge that forms a fin. For example, FIGS. 5A-5C provide an example of a lifting device 140 that includes a fin 501. In FIG. 5B, fin 501 spans across trailing edge 140b and could be coupled to the top of top disk 110. In FIG. 5C, fin 501 only extends partially towards an inner side of lifting device 140 so as to not contact top disk 110 when lifting device 140 is coupled between top disk 110 and bottom disk 120. In short, lifting device 140 can have any shape and/or configuration that creates lift.

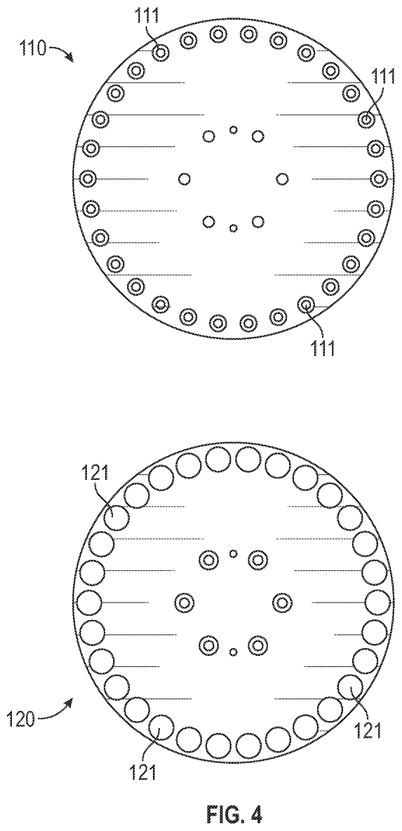

In some embodiments, cutting unit 100 may be configured to allow the position of lifting devices 140 relative to blades 130 to be customizable. For example, FIG. 4 shows an embodiment in which top disk 110 includes a circular arrangement of bolt holes 111 and bottom disk 120 includes a corresponding circular arrangement of openings 121 for receiving bolts 131 or 141. These circular arrangements of bolt holes 111 and openings 121 allow the user to customize the position of blades 130 and/or lifting devices 140. For example, a better cut may be possible for a particular length of grass by spacing lifting devices 140 at a greater distance from blades 130.

Other arrangements of bolt holes 111 and openings 121 could also be provided. For example, top disk 110 could include concentric arrangements of bolts holes 111 and bottom disk 120 could include corresponding concentric arrangements of openings 121 to allow the customization of the distance to which blades 130 and/or lifting devices 140 extend beyond the diameter of bottom disk 120.

In some embodiments, lifting devices 140 could be secured to a separate disk such as a middle disk that is positioned between top disk 110 and bottom disk 120. In such cases, customizations to the positions of lifting devices 140 relative to blades 130 could be made by rotating the separate disk relative to bottom disk 120 (e.g., by bolting the separate disk to shaft 15 at a desired rotation relative to bottom disk 120).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A cutting unit for a mower comprising:
a disk;
at least one blade that is secured to the disk and that extends outwardly beyond the disk; and
at least one lifting device that is secured to the disk, each lifting device being positioned rotationally in front of a respective blade of the at least one blade.

2. The cutting unit of claim 1, wherein the disk is a bottom disk, further comprising:
a top disk, wherein the at least one blade and the at least one lifting device are positioned between the top disk and the bottom disk.

3. The cutting unit of claim 1, wherein the at least one blade comprises a plurality of blades and the at least one lifting device comprises a corresponding plurality of lifting devices such that one of the lifting devices is positioned rotationally in front of one of the blades.

4. The cutting unit of claim 1, wherein the at least one blade and the at least one lifting device are bolted to the disk.

5. The cutting unit of claim 1, wherein each of the at least one lifting device is positioned rotationally in front of the respective blade by at least 10 degrees.

6. The cutting unit of claim 1, wherein each of the at least one lifting device are shaped to create lift as the disk is spun.

7. The cutting unit of claim 1, wherein each of the at least one lifting device forms an airfoil.

8. The cutting unit of claim 1, wherein each of the at least one lifting device has a trailing edge that forms a fin.

9. The cutting unit of claim 1, wherein the disk is configured to allow the at least one lifting device to be positioned rotationally in front of the respective blade at multiple different positions.

10. The cutting unit of claim 9, wherein the disk includes an arrangement of openings for receiving bolts that secure the at least one lifting device to the disk.

11. The cutting unit of claim 10, wherein the arrangement of openings is circular.

12. A mower comprising:
one or more cutting units, each cutting unit comprising:
a first disk;
a plurality of blades that are secured to the first disk and that extend outwardly beyond the first disk;
a plurality of lifting devices that are secured to the first disk, each lifting device being positioned rotationally in front of a respective blade of the plurality of blades.

13. The mower of claim 12, further comprising:
a second disk, wherein the plurality of blades and the plurality of lifting devices are positioned between the first and second disks.

14. The mower of claim 12, wherein the rotational position of each lifting device relative to the respective blade is customizable.

15. A cutting unit for a mower comprising:
a plurality of blades; and
a plurality of lifting devices separate from the blades, each lifting device being positioned rotationally in front of and spaced from a respective one of the blades.

16. The cutting unit of claim 15, wherein the plurality of blades and the plurality of lifting devices are secured to at least one disk.

17. The cutting unit of claim 16, wherein the at least one disk comprises a top disk and a bottom disk.

18. The cutting unit of claim 17, wherein the plurality of blades and the plurality of lifting devices are positioned between the top and bottom disks.

19. The cutting unit of claim 15, wherein the rotational position of each lifting device relative to the respective blade is customizable.

20. The cutting unit of claim 15, wherein the plurality of blades comprises at least four blades and the plurality of lifting devices comprises at least four lifting devices.
